(19) United States
(12) Patent Application Publication
(10) Pub. No.: US 2015/0064400 A1
(43) Pub. Date: Mar. 5, 2015

(54) METHOD FOR PRODUCING A SURFACE STRUCTURE USING A WATER-JET DEVICE

(71) Applicant: Hueck Rheinische GmbH, Viersen (DE)

(72) Inventor: Wolfgang Stoffel, Kempen (DE)

(21) Appl. No.: 14/378,335

(22) PCT Filed: Jun. 24, 2013
(86) PCT No.: PCT/EP2013/001852

§ 371 Date: Aug. 13, 2014

(30) Foreign Application Priority Data
Jun. 26, 2012 (EP) 12004788.1

(51) Int. Cl. B44C 1/22; B44B 5/00; B44C 5/04; B24C 1/04

(52) U.S. Cl. CPC B44C 1/221; B24C 1/04; B44B 5/0052; B44C 5/043
USPC 428/141; 451/2; 100/295

(57) ABSTRACT

The invention relates to a method for producing a surface structure (4) of a workpiece (1) in the form of a pressed sheet, endless belt, or cylindrical embossing roller using at least one water-jet device with a machining head (25). The method according to the invention allows workpiece surfaces (2) to be machined in an environmentally friendly and inexpensive manner such that the 3D topography of a surface structure of a template or of the negative of the template is reproduced. The surface (2) of the workpiece (1) is partially removed using a water jet device in the method according to the invention. Using the pressed parts machined in this manner, different materials can be pressed for example, such as particle boards with support films, wherein the 3D topography of the surface structure is reproduced on the surface of the pressed material.

### CROSS REFERENCE TO RELATED APPLICATIONS

This application is the U.S. national stage of International Application No. PCT/EP2013/001852 filed on Jun. 24, 2013, and claims the benefit thereof. The international application claims the benefit under 35 USC 119 of European Application No. EP 12004788.1 filed on Jun. 26, 2012; all applications are incorporated by reference herein in their entirety.

### BACKGROUND

The invention relates to a method for producing a surface structure of a workpiece, especially a press part such as a metallic pressing plate, endless belt or cylindrical embossing roller, with the aid of at least one water-jet device with a processing head and a device to apply the method and a composite board produced with that.

Pressing plates or endless belts are required for the production of composite boards, for instance wooden composite boards, that are supplied with a corresponding decoration for the furniture industry. Alternative possibilities for use can be seen in the production of laminated panels or laminated floor plates (floor panels). The composite boards that are used have a core, also called a substrate layer, made of medium-density fiberboard or high-density fiberboard, for instance; various material overlays are applied to this, at least on one side, that can consist, for instance, of a decorative layer and a protective layer (overlay layer). To avoid warpage of the composite boards that are used, the corresponding material overlays are likewise provided on the back side as a rule so that the composite board can be pressed together in a press using the pressing plates or endless belts. Hot presses are preferably used in connection with this, because the various material overlays are impregnated with aminoplastic resins, for instance melamine resin, and this consequently leads to fusion with the surface of the core when heat is applied. The decorative layers that are used can be structured in connection with this; a wood or tile decoration is printed on them, for instance. Alternatively, structures are used that can be artistically designed according to the respective intended use. Pressing plates and endless belts that have a negative image of the intended structure are used to improve a natural reproduction, especially in the case of wood decorations, tile decorations or natural stone surfaces and to achieve certain gloss levels. The structure that is provided involves the three-dimensional topography (called 3D topography below) of wood decorations, tile decorations or natural stone surfaces. The quality of the composite boards that are produced with a decorative layer and embossed patterns reaches a very high level of precision here because of a digitalized printing technique and digitalized production of the pressing-plate surfaces; it comes very close to that of natural wood panels or comparable materials due to a perfectly fitting alignment. Moreover, a possibility is created to generate reflections or shades that bring about the impression for a viewer of a natural or polished wood surface or other, comparable materials because of the adjustment of a certain gloss level.

To achieve the above-mentioned result, the production of the pressing plates, endless belts or cylindrical embossing rollers is subject to a high quality standard that makes, in particular, perfectly fitting or pattern-matching production possible with the decorative layers that are provided. The pressing plates and endless belts are used here as the upper and lower tools in short-cycle presses that are equipped with pressing plates or double belt presses in the case of endless belts; the embossing and heating of the material layers is done simultaneously, so the aminoplastic resins can be joined with the core via melting and hardening. The embossing rollers, in contrast, are rolled on the surface of a composite board and likewise used for structuring.

Methods for producing the pressing plates, endless belts or embossing rollers are known in the prior art that provide for the application of a decorative image in the form of a etching resist to a pretreated metallic surface, in order to create a first structure on the surface via an etching process in a subsequent etching step, and the removal, after that, of the etching resist. This work step can be repeated several times one after the other, depending on the desired surface quality, so an especially deep impression can be achieved in the surface of the pressing plate or endless belt and, furthermore, rough or fine structuring of the desired structural image. As an example, a mask is applied by means of a screen printing process to a pretreated sheet after it has been cleaned for this, it is treated with subsequent etching and the desired surface structure is created; the screen printing is applied to the large-format surface and the sheets are subsequently subjected to surface etching over the fully area. All of the areas that form the raised surface structures are covered by the mask that is applied in connection with this, so surface etching can only take place in the areas that can be directly attacked by the etching liquid. The etched-out areas then form the profile valleys of the desired structure. After the etching is done, the surface is cleaned and, in particular, the mask is removed so that the surface can be subjected to a further finishing process via other work steps, for instance hard chrome plating.

Alternatively, the possibility exists to use a photo process in which a photo-sensitive layer is first applied over the entire area. It has to then be illuminated in accordance with the intended mask to create the surface structure. After that, development of the photo layer is required. Comprehensive rinsing steps have to be done in between so that the surface can be prepared and cleaned for the next work steps. After development of the photo layer, a mask arises that is likewise called an etching template or an etching resist. The reproducibility of the masks that are created in this way is problematic, because the negative or positive that is used to illuminate the light-sensitive layer always has to be exactly positioned in the same way relative to the photo-sensitive layer. Several illumination and etching steps can follow one another to consequently bring about complex, three-dimensional structures on the surface of a pressing plate or endless belt. This is especially problematic when the negative or positive is directly laid on the light-sensitive layer for its illumination and the negative or positive does not have exactly the same spacing at every point of the photo-sensitive layer. The reproducibility of the application of the mask is not always ensured here with regard to achieving an accurate copy, especially in the case of the photo method. Other difficulties can arise when a three-dimensional structure is supposed to be created via several illumination and etching steps that are required one after the other and several masks have to be applied in sequence for this and an etching step takes place between each instance of a mask being applied. Because of the exact positioning and the required number of corresponding masks, the production of the pressing plates or endless belts is therefore very complicated and cost-intensive. The resolution of the surface structure is strongly dependent upon the mask to be applied and the process to be used here and, moreover, a substantial number of work steps are required; complex handling is required, in particular, because of the size of the pressing plates or endless belts.

Recently, there has been a shift over to directly applying the masks that are to be provided to the pressing plate with an ink-jet printer, for instance, instead of a photo process or a screen printing process, and digitalized data can be used in the process. It is ensured because of this measure that a precise image can be exactly applied to the same surface areas over and over again, so that especially deep structuring, i.e. etching of the surface, can be done. A series of etching processes are also required with this procedure, however.

In general, the structuring of surfaces of pressing plates with the aid of etching processes is to be regarded as problematic with regard to demanding environmental regulations and also increased awareness of the environment on the part of the consumer. This aspect is particularly relevant in the structuring of the surface of large-area press parts, such as pressing plates, endless belts or embossing rollers, as used in the pressing of large-area composite boards, because the etching baths have to have appropriately large dimensions. Consequently, a large volume of the chemicals to be applied also has to be used. This makes the production of press parts created via etching processes more expensive.

### DETAILED DESCRIPTION

This invention is therefore based on the problem of specifying a new type of process that can be used to process the surface of a press part, especially metallic pressing plates, endless belts or cylindrical embossing rollers, and for which an environmentally friendly and cost-effective technique can be used. The geometry of the press parts is not limited to pressing plates, endless belts or cylindrical embossing rollers, however. Block-shaped press parts can also be used whose external surfaces can optionally be structured with the process as per the invention, in order to then be able to press a material with the aid of these external surfaces. Various instances of surface structuring can be provided on the external surfaces of the block-shaped press part, so a changeover of the surface structuring to be pressed from one surface structuring to another is easily possible by a change in the orientation of the block-shaped press part.

To solve the process problem, the invention envisages that the production of a surface structure of a press part, especially a metallic pressing plate, endless belt or a cylindrical embossing roller, will be done with the aid of at least one water-jet device with a processing head; the process is comprised of the following steps:
Provision and use of digitalized data of a 3D topography of a surface structure,
Use of the digitalized data for the position control of the at least one processing head in a plane laid out by x and y coordinates, or for guided movement of a work table in a plane laid out by the x and y coordinates vis-a-vis a locally fixed processing head,
Use of the z coordinate to control the processing head, wherein the z coordinate determines the depth of the 3D topography of the surface structure,
Partial removal of material of the surface by the at least one processing head to reproduce a pre-defined 3D topography of a surface structure or its negative on a surface of a workpiece, wherein the z coordinate determines the depth of material removal.

Further advantageous design forms of the invention follow from the subordinate claims.

The press parts, such as the pressing plates, endless belts or embossing rollers, are structured with the aid of a water jet vis-a-vis the techniques that were previously used; the water jet directly generates the surface structure of the press parts to be achieved via the partial removal of material of the surface of the press parts. This procedure has a multitude of advantages. It has to first be pointed out that one can do without an etching step with this method, unless subsequent etching is desired after the production of the surface structure by means of a water jet to round out the edges. The water-jet technology can be used, for instance, for the major structuring of the surface structure of the press parts as far as this is concerned, whereas the fine structuring, on the other hand, can be done according to known methods. As an example, a mask can be applied to the intermediate product after the rough structuring with the aid of the water jet so that fine structuring can subsequently be done with the aid of etching. Alternatively, though, the possibility also exists to use a water jet with or without abrasive agents to likewise carry out partial fine structuring.

Furthermore, a processing head spraying a water jet by means of digitalized data can be precisely controlled, so the surface structure can be nearly identically reproduced a number of times. It is merely necessary with regard to this to provide digitalized data of a 3D topography of a surface structure. If it is assumed that Cartesian coordinates x, y and z are used, the z coordinate represents the depth or height of the 3D topography as a function of the coordinate pair (x, y). The coordinates x and y lay down a plane in which the surface of the press part to be processed can be arranged. The position of the processing head is controlled with the aid of the value pairs (x, y). The advancing speed of the processing head in the x and/or y direction, the water pressure, the spraying time or the distance between the surface to be processed and the processing head is controlled with the aid of this z coordinate assigned to the value pair. The advancing speed of the processing head in the x and/or y direction can be determined from the spraying time of neighboring points on the press-part surface, and thus neighboring value pairs (x, y). The advancing speed of the processing head can therefore also be controlled with the aid of the z coordinate of the digitalized 3D topography of the surface structure of a template. The volume flow rate of the water can also be controlled with the aid of the z coordinate, however.

Several processing heads can be used for processing in one coordinate direction in a plane laid out by the x and y coordinates and can be jointly advanced in the direction of the further coordinate in the method for production of a surface structure as per the invention. Alternatively, guided movement of the work table can be done; the processing head of the water-jet device or the several processing heads of the water-jet device can be locally fixed in place in the process.

Using a high-pressure water jet to cut metallic workpieces to size is known in the area of metal processing. Very large metallic workpieces that only have to be cut to size are possibilities here. But very small metallic elements, which are intended to be used in an electromechanical device, for instance, are also cut out of a larger workpiece. As an example, small gears or lever constructions can be cut out of a metallic workpiece. The advantages of metal processing with a high-pressure water jet are used for the surface structuring of press parts as per the invention.

The major advantage of the water-jet cutting or the surface structuring of metallic or non-metallic workpieces vis-a-vis customary cutting methods, such as sawing or laser cutting, is the low thermal and mechanical stress on the workpiece to be cut, especially on the cut surface. The water-jet cutting involves a cold-cutting process in which the cut surface does not significantly exceed a temperature of approx. 50° C. There are no material changes to the proximity of the cut surface due to the input of thermal energy because of that. Furthermore, the mechanical stress on the cut surface is relatively low, because the water jet does not rip small volume elements out of the workpiece. Because of this, there is no mechanical stress on large areas of the cut surface that could result in cracks arising or other geometrical flaws. In the water-jet cutting process, in contrast, the force that is transferred to the entire cut surface is approximately five newtons, and that is consequently low in comparison to the customary methods. The advantageous characteristics of water-jet workpiece processing have not been used up to now for the three-dimensional surface structuring of workpieces, especially press parts. Rather, the etching processes that have been described for the surface structuring of workpieces, especially press parts, have to be used and the drawbacks that have likewise been stated have to be accepted.

A water-jet device for use in the method as per the invention comprises at least one high-pressure pump unit, at least one water-supply element and at least one processing head with a water nozzle. The at least one water-supply element can involve a rigid pipe carrying water or a flexible hose carrying water. A locally fixed processing head has the advantage that it can be rigidly mounted. Because of that, a situation can be prevented in which system vibrations are transferred from the high-pressure pump unit or the at least one water-supply element to the at least one processing head, which would result in a lower level of structuring precision. A rough structuring of the surface, but likewise a fine structuring of the surface, can be done via the method as per the invention, so an etching process is unnecessary and it only needs to be carried out if edges that arise have to be additionally rounded off, for instance.

A further important advantage arises because of the fact that the surface structure can be reproduced any number of times via digitalized data and this can be done without complex control measures; monitoring activity of the operating personnel can be reduced to a minimum. Doing without complex, cost-intensive and environmentally harmful etching processes can be mentioned as a further important advantage.

A structuring depth of up to 6 mm can be generated with the method as per the invention in dependence upon the desired depth of the structure to be formed on the surface of the workpiece, especially the press part. The parameters of the advancing speed of the processing head, the water pressure, the volume flow rate, the spraying time or the distance between the surface to be processed and the processing head are to be chosen appropriate for this. The structuring is preferably done via the control of the advancing speed. The depth of up to 6 mm that is to be produced with the aid of the processing head is in line with the intended purpose. As an example, a rough structuring of the surface up to a depth of 6 could be done and subsequently a fine structuring according to customary methods, for instance by means of a mask and etching processes. But if the processing head is used for fine structuring, slight depths of 1 mm, preferably of 500 μm, are produced. If necessary, the structuring depth can be further reduced if only a slight structuring depth is desired.

In a further advantageous design form of the method as per the invention, the water nozzle of the at least one processing head has a distance to the surface to be processed of 1 mm to 5 mm, preferably 1.5 mm to 2.5 mm. A further advantageous design form of the method as per the invention envisages that the water jet from the at least one water nozzle is incident on the surface of the workpiece, especially a press part, at an angle to the plane laid out by the x and y coordinates and is especially incident at an angle of 90 degrees to the structure wall to be created, or that the forming of the surface structure can be achieved by a pendulum motion of the processing head; the orientation of the water jet can be continuously varied, at least at certain times, in such a way that the water jet is moved over a cone envelope to provide for optimal processing of the existing structural wall. In the method as per the invention, there can be provisions for the tilt and/or the orientation of the water jet being sprayed out of the processing head to be quickly varied with respect to the surface to be processed; shaping of the surface structure, for instance in the form of recesses in the surface to be processed, can be achieved because of that. The method as per the invention further envisages that the diameter of the water jet of the at least one water nozzle or water micro-nozzle is set to a value between 0.05 mm and 2.0 mm. The range of 0.10 mm to 0.40 mm can be chosen as an especially preferred range of the diameter of the water jet from the at least one water nozzle or water micro-nozzle. The water jet that is sprayed out widens to approximately twice the dimension before impacting the surface to be processed.

A further design form of the invention envisages that the at least one processing head can be moved in a translatory fashion along three axes, which is why the processing head can be moved to any position (x, y). Furthermore, the processing head can be rotated around three axes, preferably two axes; the generation of vertical and oblique sections of the surface structure is advantageously made possible because of that. Moreover, the processing head can be arranged on a guide arm that has, for its part, at least one translatory or rotational axis.

High water pressure is required so that the method for producing a surface structure can also be carried out on pressing plates, endless belts or cylindrical embossing rollers that are made of very hard material. The method as per the invention therefore uses a high-pressure pump unit that generates a pressure of 1,200 to 4,100 bar; the pressure can be adapted to the hardness of the material to be processed.

When structuring the surface of especially hard materials, the application of a pure water jet can only achieve the desired result over an unsatisfactorily long period of time under certain circumstances. A further design form of the invention therefore envisages use of a water jet that includes an abrasive agent. Fine-pored, sharp-edged sand or metallic and semiconductor oxides, carbines or nitrides with a grain of >30 mesh size, for instance, are possibilities here. The use of a water—abrasive-agent jet results in quicker material removal. Furthermore, the sand grains act as an abrasive agent and deburr the surface to be processed. The structuring precision of a jet of that type is also lower, though, because the volume elements that are ripped out of the workpiece to be processed when the water—abrasive-agent jet hits are larger than those that are ripped out when a pure water jet is used. One variant or the other can therefore be used depending on the hardness of the material whose surface is to be structured; an abrasive agent could be used for rough structuring, and only a water jet could be used for fine structuring. Corundum, among other agents, is a known and proven abrasive agent because the grains of the corundum more likely have sharp edges instead of rounded edges. Corundum has the significant advantage here that the grains of the corundum will also not lose this advantageous characteristic after the use of water—abrasive-agent jet cutting.

In an advantageous design form of the method for production of a surface structure, the surface structure is divided up into subordinate areas, regardless of a repeating structure pattern, that can each be sequentially processed by a water-jet device or that can at least partially be processed in parallel by several water-jet devices. The borders of the subordinate areas can be freely chosen in the process and are preferably established in such a way that the borders coincide with the non-processed areas of the surface to avoid possible structural defects.

In a preferred design form of the process, the subordinate areas that are established have an edge length of 10 cm to 100 cm in dependence upon the water-jet device to be used. Edge lengths of 50 cm are especially preferred here.

In a further advantageous design form of the process, at least individual areas of the surface to be processed are processed a number of times. Areas that are processed one after the other can fully or partially overlap, for instance.

In a further design form of the process, the workpiece to be processed is arranged to lie in a water basin. The surface of the workpiece that is to be processed, for instance a pressing plate, is consequently under water. The water nozzle of the processing head is arranged to be at a distance of 1 mm to 5 mm from the surface to be processed and is consequently likewise located under the water level in the basin. It can thereby be ensured that the heat generated at the cutting surface via friction is quickly dissipated. Furthermore, the backscattering of the abrasive-agent grains from the surface to be processed or the backscattering of workpiece particles ripped out by the water jet or the water—abrasive-agent jet is prevented by the arrangement of the workpiece to be processed and the water nozzle beneath the water level. The industrial safety in the environment of the implementation of the method is increased because of that, and the risk of splashing is significantly reduced at the same time. Moreover, the noise level that arises because of that in the execution of the process is very low.

Furthermore, in the process as per the invention, measurement points can be provided on the surface of the workpiece to be processed, for instance a pressing plate, that allow a check of the position of the processing head at any time, so corrective control can be used or an interrupted processing step can be continued at any time; the processing head can be set down again, precisely targeted, at the position that was last selected.

In an advantageous design form of the process as per the invention, digitalized data of a 3D topography of a surface structure of naturally grown, raw materials, for instance wood surfaces or natural minerals such as natural stone surfaces, in particular, or artificially created structures, for instance ceramic surfaces, are used as a template.

The digitalized data can be acquired with the aid of a scanner, for instance, that faithfully acquires the entire 3D topography of a surface structure of a template with the aid of a redirectable mirror technique, or it can be acquired via sampling of the entire 3D topography of a surface structure of a template with the aid of a laser beam redirected by at least one mirror and the reflections obtained from that. The digitalized data can be used to establish a 3D topography of a surface structure in the form of gray-scale images for the surface structuring. In the process, the color scale between white and black is divided up into a desired number of intervals. After that, a numerical value is assigned to each interval. The number zero is assigned to the interval that corresponds to the color white or the interval that corresponds to the color black. The intervals are then numbered consecutively up to the opposite end of the color scale. The z coordinate can then take on the numerical values corresponding to the intervals or any arbitrary multiple of that and use them to control the advancing speed of the at least one processing head in the x and/or y direction, the water pressure, the volume flow rate, the spraying time or the distance between the surface to be processed and the processing head.

There can be provisions here for the digital data that is acquired to be converted via interpolation and data reduction to control the advancing speed of the at least one processing head in the x and/or y direction, the water pressure, the volume flow rate, the spraying time or the distance between the surface to be processed and the processing head.

Furthermore, a device is proposed to carry out the method as per the invention that comprises a support unit for the workpieces to be processed, especially pressing plates and endless belts, at least one water-jet device with a processing head and a carriage track for moving the at least one processing head into an arbitrary position within a plane laid out by x and y coordinates, or the guided movement of a work table vis-a-vis a locally fixed processing head and independent drive elements for movement to a position (x, y) and a control unit that is provided for the processing head to move to positions.

The device distinguishes itself by the fact that the movement to the x and y coordinates takes place via preset digitalized data of a 3D topography of a surface structure, and the z coordinate is used to control the processing head; the z coordinate represents the depth or height of the 3D topography, and material can be partially removed from the surface with the aid of the at least one processing head. In the process a reproduction of the 3D topography or its negative is made on the surface of a workpiece.

In accordance with the method as per the invention that has been described, the z coordinate of the digitalized 3D topography of a surface structure is used by the device to control the advancing speed of the processing head in the x and/or y direction, the water pressure, the volume flow rate, the spraying time or the distance between the surface to be processed and the processing head. The listed parameters can be used individually or in any combination for control.

The device can comprise a processing head or several processing heads that are arranged in a coordinate direction in the plane and that can jointly move in the direction of the other coordinates. A control unit is provided for the at least one processing head to move to positions. Alternatively, or additionally, guided movement of the work table can be done in three dimensions via suitable, independent driving units.

Moreover, the device is characterized in that the water-jet device can comprise at least one locally fixed high-pressure pump unit with connection lines to a movable processing head with a water-supply element and a water nozzle.

In an especially advantageous design form of the device as per the invention, the processing head of the water-jet device can track at a distance of 1 mm to 5 mm, preferably 1.5 mm to 2.5 mm, vis-a-vis the surface and is arranged so as to be capable of control by a control unit. A situation can thereby be brought about in an advantageous way that the distance between the processing head and the surface to be processed can be kept constant even when there is bending of a large-area, flexible workpiece or other types of unevenness. This feature advantageously increases the structuring precision of the devices.

A special design form of the device envisages that the processing head is guided so as to be capable of translational movement along three axes and is rotated around three axes, preferably two axes, or the orientation of the water jet can be continuously varied, at least at certain times, in such a way that the water jet is moved over a cone envelope. Moreover, the processing head can be arranged on a guide arm that has, for its part, at least one translatory or rotational axis. Furthermore, the processing head of the water-jet device has at least one height and/or collision protection sensor. A situation is thereby brought about in an advantageous way that unevenness and bending of a large-area workpiece are recognized, and a collision of the processing head with the workpiece insert to be processed is avoided and, on the other hand, a constant distance is kept to the surface. When structuring the surface of especially hard workpieces, especially pressing plates, it can be advantageous as mentioned above to not use a pure water jet, but instead a water jet that also involves an abrasive agent. Fine-pore sand, in particular, is a possibility for use in the device as an abrasive agent. The device can have a closed water circulation system with filtering equipment in connection with this to filter out abrasive agents, so the abrasive agent can be recovered and the water can be used again. The workpiece particles that are disengaged and the abrasive grains from the collected water are to be filtered for this.

Furthermore, at least one processing head can be arranged in the device in such a way that the water jet from the water nozzle of the processing head is incident on the surface to be processed at an angle to the plane laid out by the x and y coordinates; there are especially provisions for the water jet to hit the structure wall of a surface structure in a perpendicular fashion or for oscillating movement to be carried out to process lateral surfaces.

Moreover, the device has at least one high-pressure pump unit that generates a water jet with a travel velocity of up to 1000 meters per second, which can be used for structuring without abrasive agents.

The water nozzle of the processing head of the device is exposed to special stresses in connection with this. This is especially the case when a water—abrasive-agent jet is used, but the water nozzle is also exposed to high levels of stress when a pure water jet is used. This is why the water nozzle or water micro-nozzle of the at least one processing head is made, at least partially, of monocrystalline or polycrystalline diamond or a material that essentially consists of Al₂O₃. The service life of the water nozzles or water micro-nozzles that are used will be significantly increased because of that. Nevertheless, these especially wear-resistant materials will not prevent the water nozzle from having to be replaced on a regular basis.

The device as per the invention has a support unit, which is comprised of a level, flat surface divided up into a number of subordinate areas, for the most precise possible processing of the surface to be processed. Suction devices for a vacuum-suction unit, which could involve suction openings with an elastic rubber seal or suction bells, are arranged in the subordinate areas. The workpiece to be processed, for instance a pressing plate, can be fixed in place on the support unit because of that, and it will not slip when there are jolts to the overall water-jet device or the workpiece due to the water jet or water—abrasive-agent jet that is operating. There can also be provisions for support elements, for instance an arrangement of crossbars in the water basin, on which the workpiece can be laid.

The finished pressing plates, endless belts or cylindrical embossing rollers can be subjected to further treatment processes after the structuring is done. As an example, several chrome layers with different gloss levels can be applied; chrome plating is first applied over the full area, and either the raised or the lower-lying areas of the surface structuring are covered by a mask so that at least one second chrome layer can be subsequently applied. Alternatively, the possibility exists to influence the gloss level via gloss baths, mechanical post-treatment or surface etching. At the end of these further process steps, the pressing plate, the endless belt or the cylindrical embossing roller is finished and can be used for the intended applications.

The surface structuring of the press parts, especially a metallic pressing plate, endless belt or cylindrical embossing roller, that is created with the aid of the water structuring is intended to be used to press and/or emboss composite boards with a natural, structured surface with a depth of up to 6 mm; preset digitalized data of a 3D topography of a surface structure is used in the process to control movement to the x and y coordinates, and the z coordinates that represent the depth of the 3D topography are used to control the advancing speed of the at least one processing head in the x and/or y direction, the water pressure, the volume flow rate, the spraying time or the distance between the surface to be processed and the processing head, wherein the surface is partially processed and a predetermined 3D topography of a surface structure is reproduced by removing the material.

The invention further relates to a pressing plate, an endless belt or a cylindrical embossing roller manufactured according to one of the method claims using the device as per the invention.

Moreover, the invention relates to a composite board with a surface that is at least partially embossed, produced using a pressing plate or endless belt, that was manufactured according to one of the method claims using a device according to one of the device claims.

The special advantage of this invention is that the surface processing of the pressing plates, endless belts or cylindrical embossing rollers is done with the aid of a water jet and complex etching processes can be eliminated, at least in a first step. The possibility exists here with the aid of the water-jet processing to at least carry out the major structuring, which will be subsequently processed with the aid of a second processing step either via a water jet or via the use of customary methods, for instance etching processes, to do the fine structuring; a mask can be applied with the aid of digital printing for this purpose.

### BRIEF DESCRIPTION OF THE DRAWINGS

The invention will be explained in more detail below with the aid of the figures. The drawings show the following:

FIG. 1 shows, in a cross-sectional view, the surface of an unprocessed workpiece and, in a cross-sectional view underneath that, the surface of a workpiece structured with a water jet,

FIG. 2 shows, in a top view, an embodiment of the device for carrying out the method as per the invention,

FIG. 3 shows, in a top view, a further embodiment of the device for carrying out the method as per the invention and

FIG. 4 shows, in a perspective view, a device for carrying out the method as per the invention.

### DETAILED DESCRIPTION OF THE PREFERRED EMBODIMENT

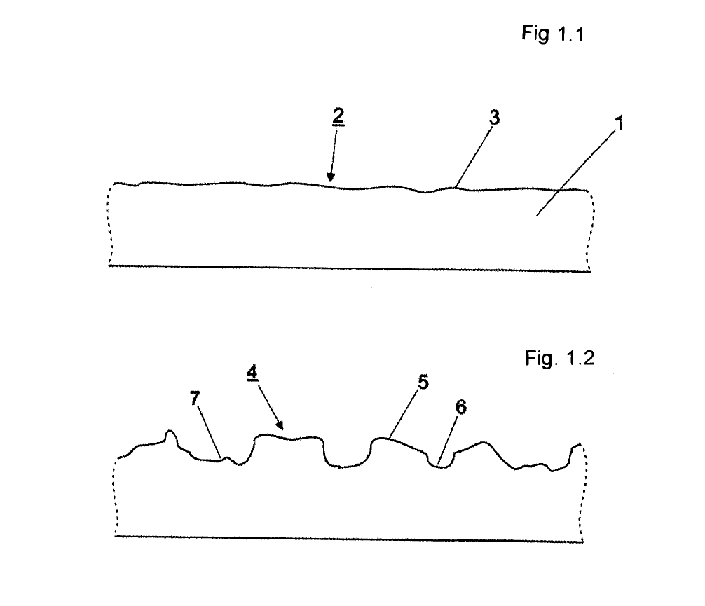

FIG. 1 shows a workpiece 1 in a cross-sectional view; this could involve a pressing plate for pressing materials, which is typically a metallic pressing plate. A surface 2 that is to be processed has a surface roughness 3 that is customary according to the particular manufacturing process before the processing. After preliminary cleaning of the workpiece 1, a surface structure 4 is created via the method as per the invention that distinguishes itself by raised areas 5 and lower-lying areas 6 in accordance with the lower partial view. Both the raised areas 5 and the lower-lying areas 6 have fine structuring 7. The entire structure of the surface of the workpiece 1 is created with the aid of the method as per the invention here; different levels of material removal are accomplished by appropriate control of a processing head. FIG. 1 shows fine structuring 7 in connection with this and rough structuring that was schematically portrayed for better clarity; it is to be assumed, however that a depth of up to 500 μm will not be exceeded.

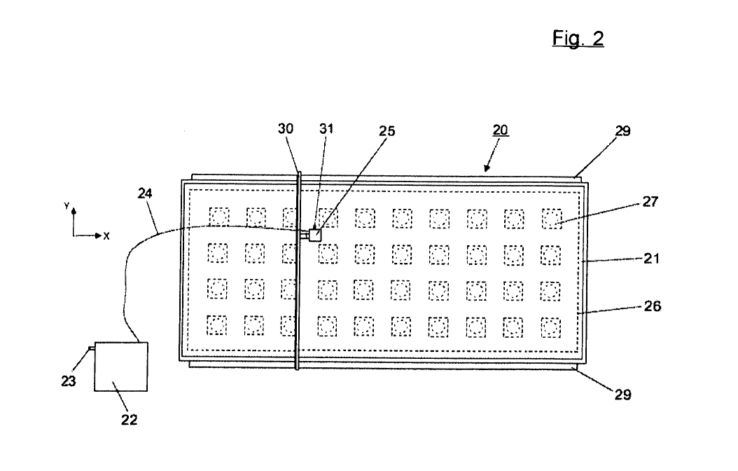

FIG. 2 shows, in a top view, a device 20 for carrying out the method as per the invention. The device is comprised of a water basin 21 in which a support unit 26 is arranged. There are recesses in the support unit 26 in which suction devices 27 are arranged that could be suction openings with an elastic rubber seal or suction bells. The workpiece whose surface 2 is to be processed can be fixed in place flat on the support unit 26 because of that. Furthermore, the device has a high-pressure pump unit 22 with connection lines 23. The high-pressure pump unit 22 is supplied with water through the connection lines 23.

This could involve recovered water that had already previously been used for the surface structuring of the workpiece 1. The water is supplied to a processing head 25 via a water-supply element 24. An abrasive agent that is absorbed in the water that is quickly flowing in the water nozzle, causing a water—abrasive-agent jet to be sprayed out of the water nozzle, can be supplied to the processing head 25 via an abrasive-agent connector 31.

The processing head 25 is moved in the x direction with the aid of two guide rails 29 in the x direction. The processing head 25, which is arranged in a movable fashion in the y direction on the guide rail 30, is moved in the y direction with the aid of a further guide rail 30 that is mounted in a movable fashion on the guide rails 29 in the x direction. It is also possible with an appropriate design of the device to only provide one guide rail in the x direction. The processing head 25 can move to any position (x, y) of the surface 2 because of the superposition of the movements in parallel with the guide rails 28, 29. The depth of material removal at the position (x, y) of the surface 2 is controlled as per the invention by the advancing speed of the processing head 25 in the x and/or y direction, the water pressure, the volume flow rate, the spraying time or the distance between the surface 2 and the processing head 25.

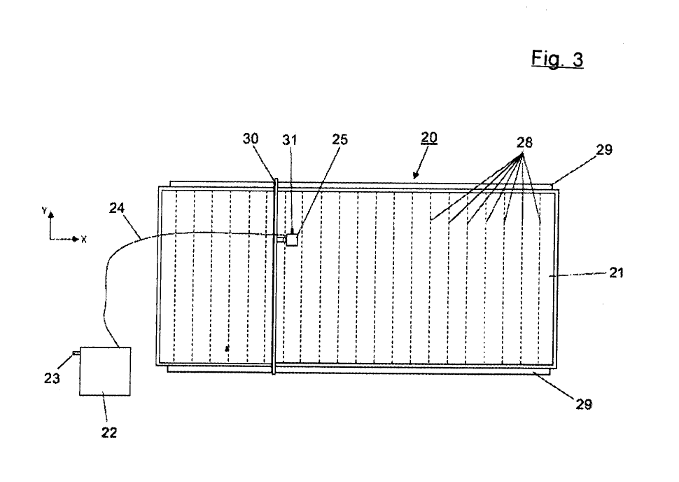

FIG. 3 shows, in a top view, a device 20 for carrying out the method as per the invention. The device is comprised of a water basin 21 in which support elements 28 are arranged. The support elements 28 can be designed to be horizontally oriented lands or vertically oriented plates. The workpiece is laid on the support elements 28. Furthermore, the device has a high-pressure pump unit 22 with connection lines 23. A water-supply element 24 leads the water from the high-pressure pump unit 22 to the processing head 25. The processing head 25 is moved in the x direction with the aid of two guide rails 29 in the x direction. The processing head is moved in the y direction with the aid of a further guide rail 30 in the y direction, which is mounted in a movable fashion on the guide rails 29 in the x direction. The processing head 25 is mounted in a movable fashion on the guide rail 30 in the y direction. The processing head 25 can move to any position (x, y) of the surface 2 because of the superposition of the movements in parallel with the guide rails 29, 30. An abrasive-agent connector 31 is also provided in this embodiment of the device so that a water—abrasive-agent jet can be used. The depth of material removal at the position (x, y) of the surface 2 is controlled as per the invention by the advancing speed of the processing head 25 in the x and/or y direction, the water pressure, the volume flow rate, the spraying time or the distance between the surface 2 and the processing head 25.

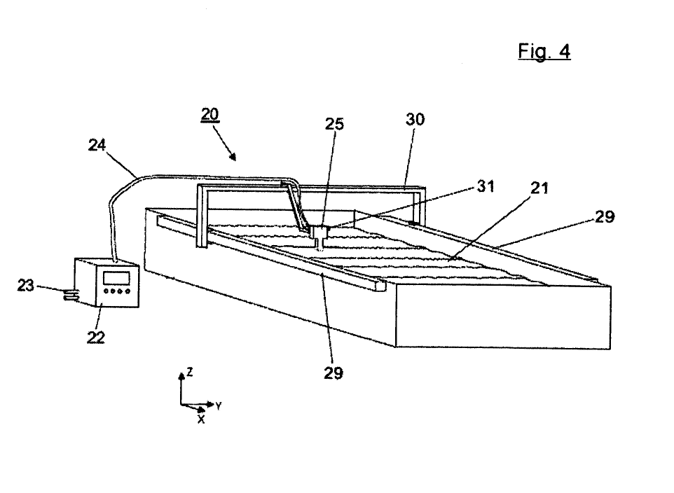

FIG. 4 shows, in a perspective view, the embodiments of FIGS. 2 and 3 of a device 20 for carrying out the method as per the invention. The device is comprised of a water basin 21. Two guide rails 29 are arranged in the x direction on the water basin 21. A guide rail 30 in the y direction is mounted in a movable fashion on the guide rails 29. The processing head 25 is mounted in a movable fashion on the guide rail 30 in the y direction, so movement can be done to each position (x, y). Two guide rails in the y direction that are fastened to the water basin 21 and a guide rail in the x direction that is mounted in a movable fashion on it can naturally also be provided; the processing head 25 will then be mounted in a movable fashion on the guide rail in the x direction. These design forms and other, equivalent design forms of the device 20 for carrying out the method as per the invention are not ruled out by the concrete forms specified in FIGS. 2 to 4.

### LIST OF REFERENCE NUMERALS

1 Workpiece
2 Surface
3 Surface roughness
4 Surface structure
5 Raised area
6 Lower-lying area
7 Fine structuring
20 Device
21 Water basin
22 High-pressure pump unit
23 Connection lines
24 Water-supply element
25 Processing head
26 Support unit
27 Suction device
28 Support element
29 Guide rail in the x direction
30 Guide rail in the y direction
31 Abrasive-agent connector

1. Method for creating a surface structure (4) of a workpiece (1) in the form of a pressing plate, endless belt or cylindrical embossing roller with the aid of at least one water-jet device with a processing head (25), comprising the steps:
provision and use of digitalized data of a 3D topography of a surface structure,
use of the digitalized data for the position control of the at least one processing head (25) in a plane laid out by x and y coordinates, or for guided movement of a work table in the plane laid out by x and y coordinates vis-a-vis a locally fixed processing head (25),
use of the z coordinate to control the processing head (25), wherein the z coordinate determines the depth of the 3D topography of the surface structure,
partial removal of material of the surface (2) by the at least one processing head (25) to reproduce a pre-defined 3D topography of a surface structure or its negative on a surface (2) of the workpiece (1), wherein the z coordinate determines the depth of material removal.

2. Method for creating a surface structure (4) according to claim 1,
characterized in that
the z coordinate of the digitalized data of the 3D topography is used to control the advancing speed of the processing head (25), or guided movement of the work table in the x and/or y direction, the water pressure, the volume flow rate,
the spraying time or the distance between the surface (2) to be processed and the processing head (25).

3. Method for creating a surface structure (4) according to claim 1,
characterized in that
several processing heads (25) are used for processing in a coordinate direction in a plane and are jointly moved ahead in the direction of the further coordinate, or there is guided movement of the work table.

4. Method for creating a surface structure (4) according to claim 1,
characterized in that
the water-jet device is comprised of at least one high-pressure pump unit (22), at least one water-supply element (24) and at least one processing head (25) with a water nozzle, and/or that material of the surface (2) to be processed is removed up to a depth of 6 mm with the aid of the water nozzle of the water-jet device and/or that the water nozzle is subjected to guided movement at a preselected distance to the surface (2) to be processed of 1 mm to 5 mm, preferably 1.5 mm to 2.5 mm.

5. Method for creating a surface structure (4) according to claim 1,
characterized in that
the water jet from the water nozzle is incident at the surface (2) perpendicular to the structure wall to be created at an angle to the plane laid out by the x and y coordinates and/or that the water jet can be set with the aid of a water nozzle or water micro-nozzle to a diameter of 0.05 mm to 2.0 mm or 0.10 mm to 0.40 mm.

6. Method for creating a surface structure (4) according to claim 1,
characterized in that
the processing head (25) is guided so as to be capable of translational movement along three axes and is rotated around at least two axes, or the orientation of the water jet can be continuously varied, at least at certain times, by the control unit of the processing head (25) in such a way that the water jet is moved over a cone envelope.

7. Method for creating a surface structure (4) according to claim 1,
characterized in that
the water-jet device is operated without or with an abrasive agent, wherein fine-pored, sharp-edged sand, metallic and semiconductor oxides, carbides or nitrides with a grain >30 mesh size is used as the abrasive agent, and/or that the water-jet device is used with a high-pressure pump unit (22) with 1,200 to 4,100 bar.

8. Method for creating a surface structure (4) according to claim 1,
characterized in that
the surface structure (4) is divided up into subordinate areas, regardless of a repeating structure pattern, that can each be sequentially processed by a water-jet device or that can at least partially be processed in parallel by several water-jet devices, wherein the subordinate areas can overlap one another and/or the borders of the subordinate areas can be freely chosen, preferably established in such a way that the borders coincide with unprocessed areas of the surface (2).

9. Method for creating a surface structure (4) according to claim 8,
characterized in that
the subordinate areas that are established in dependence upon the water-jet device that is used have an edge length of 10 cm to 100 cm, preferably 50 cm, and/or that the subordinate areas that are established are processed under water with a processing head (25) and an accompanying water nozzle.

10. Method for creating a surface structure (4) according to claim 1,
characterized in that
measurement points are provided on the surface (2) that allow a check of the position of the processing head (25) at any time, so corrective control can be used or an interrupted processing step can be continued.

11. Method for creating a surface structure (4) according to claim 1,
characterized by the use of digitalized data of a 3D topography of a surface structure reproduced from naturally grown raw materials, such as wood surfaces, or natural minerals such as natural stone surfaces, or artificially created structures such as ceramic surfaces, and/or characterized by the use of a 3D scanner for acquiring the digitalized data, which acquires the entire 3D topography of the surface structure in a true-to-nature way with the aid of redirectable mirrors or acquires it via sampling of the entire surface structure of the template with the aid of a laser beam redirected by at least one mirror and the reflections received from that, or characterized by the use of grayscale images to create a 3D topography of a surface structure.

12. Method for creating a surface structure (4) according to claim 1,
characterized by a conversion of the digital data that is acquired via interpolation and data reduction to control the advancing speed of the processing head (25) in the x and/or y direction, the water pressure, the volume flow rate, the spraying time or the distance between the surface (2) to be processed and the processing head (25).

13. Device (20) for applying the method according to claim 1, comprising a support unit (26) for the materials to be processed, at least one water-jet device with a processing head (25) and a carriage track on guide rails (29, 30) for moving the at least one processing head (25) into an arbitrary position within a plane laid out by x and y coordinates, or the guided movement of a work table vis-a-vis a locally fixed processing head (25), and independent drive elements for movement to a position and a control unit that is provided for positioning the processing head (25) or the work table,
characterized in that
movement to x and y coordinates is performed via preset digitalized data of a 3D topography of a surface structure, and the z coordinate is used to control the processing head (25), wherein the z coordinate determines the depth of the 3D topography and the partial removal of material from the surface (2) of a workpiece (1) in the form of a pressing plate, endless belt or cylindrical embossing roller with the aid of the at least one processing head (25).

14. Device (20) according to claim 13,
characterized in that
the z coordinate of the digitalized data of the 3D topography of a surface structure can be used to control the advancing speed of the processing head (25), or guided movement of the work table in the x and/or y direction, the water pressure, the volume flow rate, the spraying time or the distance between the surface (2) to be processed and the processing head (25).

15. Device (20) according to claim 13,
characterized in that
one or more processing heads (25) are arranged in one coordinate direction in the plane and can be jointly moved in the direction of the further coordinate, and/or that the water-jet device is comprised of at least one locally fixed high-pressure pump unit (22) with connection lines (23) to a movable processing head (25) with a water-supply element (24) and at least one water nozzle.

16. Device (20) according to claim 13,
characterized in that
the processing head (25) of the water-jet device can be guided at a distance of 1 mm to 5 mm, preferably 1.5 mm to 2.5 mm, vis-a-vis the surface (2) and is arranged so as to be capable of being controlled by a control unit, and/or that the processing head (25) is guided so as to be capable of translational movement along three axes and can be rotated around at least two axes, or the orientation of the water jet can be continuously varied, at least at certain times, in such a way that the water jet is moved over a cone envelope.

17. Device (20) according to claim 13,
characterized in that
the processing head (25) der water-jet device has at least one height and/or collision protection sensor, and/or that the water-jet device is operated with or without an abrasive agent and/or has a closed water circulation system with filtering equipment to filter out the abrasive agents and the workpiece particles that have been removed.

18. Device (20) according to claim 13,
characterized in that
the water jet from the water nozzle is incident perpendicular to the structure wall of a surface (2) to be processed at an angle to the plane laid out by the x and y coordinates and/or that the water-jet device has at least one high-pressure pump unit (22) that generates a water jet with a travel velocity of up to 1,000 meters per second.

19. Device (20) according to claim 13,
characterized in that
the water nozzle or water micro-nozzle of the at least one processing head (25) is comprised, at least partially, of monocrystalline or polycrystalline diamond or a material that essentially consists of Al2O3, and/or that the support unit (26) has a level, flat surface that is divided up into a number of sub-areas and has suction devices (27) for a vacuum-suction unit in the sub-areas, and/or that the support unit is made of at least one support element (28).

20. Pressing plate, endless belt or cylindrical embossing roller, manufactured according to method claim 1 using a device according to claim 13 for pressing and/or embossing composite boards, which get a natural surface structure (4) down to a depth of 6 mm via the pressing process, wherein preset digitalized data of a 3D topography of a surface structure is used for movement to the x and y coordinates when structuring the surface (2) of the pressing plate, endless belt or cylindrical embossing roller, and the z coordinate of the digitalized data determines the depth of the 3D topography and is used to establish the advancing speed of the at least one processing head (25), or the guided movement of a work table in the x and/or y direction, the water pressure, the volume flow rate, the spraying time or the distance between the surface (2) to be processed and the processing head (25), wherein the surface (2) is partially processed and there is a reproduction of a predetermined 3D topography of a surface structure or its negative on the surface (2) of the pressing plate, endless belt or cylindrical embossing roller via removal of material.

21. Composite board with a surface that is at least partially embossed using a pressing plate, endless belt or embossing roller that is embossed according to method claim 1 using a device according to claim 13.
